(19) United States
(12) Patent Application Publication
(10) Pub. No.: US 2020/0001840 A1
(43) Pub. Date: Jan. 2, 2020

(54) BRAKING CONTROL DEVICE FOR VEHICLES

(71) Applicant: ADVICS CO., LTD., Kariya-shi, Aichi-ken (JP)

(72) Inventors: Masanao SAWADA, Toyoake-shi, Aichi-ken (JP); Takuma SASAKI, Kariya-shi, Aichi-ken (JP)

(73) Assignee: ADVICS CO., LTD., Kariya-shi, Aichi-ken (JP)

(21) Appl. No.: 16/492,217

(22) PCT Filed: Mar. 20, 2018
(86) PCT No.: PCT/JP2018/011196

§ 371 Date: Sep. 9, 2019

(30) Foreign Application Priority Data
Mar. 21, 2017 (JP) 2017-054784

(51) Int. Cl. B60T 8/17; B60T 7/12; B60T 13/16; B60T 13/68

(52) U.S. Cl. CPC B60T 8/17; B60T 7/12; B60T 13/62; B60T 13/686; B60T 13/161

(57) ABSTRACT

This control device which serves as a brake control device is provided with: a valve control unit for controlling a differential pressure regulation valve and a holding valve; and a motor control unit for controlling an electric motor serving as a power source of a pump. When a predetermined condition is satisfied during an automatic braking process to decelerate a vehicle, the valve control unit implements a valve opening change control routine wherein the holding valve is set to a lower opening degree than that before the predetermined condition.

### TECHNICAL FIELD

The present invention relates to a braking control device for vehicles that executes an automatic braking process for decelerating the vehicle by increasing the fluid pressure in a wheel cylinder.

### BACKGROUND ART

Patent Literature 1 describes an example of a braking actuator that operates to regulate the fluid pressure in a wheel cylinder provided for a wheel. Such a braking actuator includes a differential pressure regulation valve disposed in a fluid path connecting the master cylinder and the wheel cylinder, and an electric pump that discharges the brake fluid toward the wheel cylinder side than the differential pressure regulation valve in the fluid path. The fluid pressure in the wheel cylinder can be made higher than the fluid pressure in the master cylinder by regulating the opening degree of the differential pressure regulation valve while discharging the brake fluid from the pump.

Furthermore, according to Patent Literature 1, the drive of an electric motor which is a power source of a pump is stopped when an accelerator operation or a braking operation is performed under the situation where the fluid pressure in the wheel cylinder is regulated by the operation of such a braking actuator. Thus, excessive heat generation in the electric motor can be suppressed.

When the discharge amount of the brake fluid from the pump is reduced under the situation where the fluid pressure of the wheel cylinder is regulated by the operation of the braking actuator, the fluid pressure in the wheel cylinder may lower due to the reduction in the discharge amount. Therefore, in recent years, a braking control device that regulates the differential pressure command current value with respect to the differential pressure regulation valve so that the opening degree of the differential pressure regulation valve becomes smaller when the operating speed of the electric motor is low than when the operating speed is high is also known. When the braking actuator is operated by such a braking control device, the differential pressure command current value can be made to a value corresponding to the discharge amount of the brake fluid from the pump. Thus, the amount of brake fluid flowing out from the wheel cylinder side to the master cylinder side relative to the differential pressure regulation valve can be reduced the lesser the discharge amount, whereby variation in the fluid pressure in the wheel cylinder caused by the difference in the discharge amount can be suppressed.

### CITATIONS LIST

### Patent Literature

Patent Literature 1: Japanese Unexamined Patent Publication No. 2014-189135

### SUMMARY OF INVENTION

### Technical Problems

When a vehicle body deceleration of the vehicle reaches a target value during execution of the automatic braking process for decelerating the vehicle by increasing the fluid pressure in the wheel cylinder, it is conceivable to reduce the operating speed of the electric motor, that is, to reduce the brake fluid from the pump for the purpose of reducing the load of the electric motor. At this time, since the change mode of the operating speed in the transition period, during which the operating speed of the electric motor is reducing, changes depending on the viscosity of the brake fluid, and the like, it is difficult to accurately grasp the transition of the operating speed in the transition period. In particular, when the operating speed is rapidly reduced as in the case where the drive of the electric motor is stopped, the transition of the operating speed cannot be grasped. Therefore, even if a control for setting the differential pressure command current value to a value corresponding to the operating speed of the electric motor is applied, it is difficult to change the differential pressure command current value according to the actual change mode of the operating speed in the transition period, and hence the lowering in the regulation accuracy of the fluid pressure in the wheel cylinder becomes a concern.

### Solutions to Problems

A braking control device for vehicles for solving the problems the described above is applied to a braking device including a differential pressure regulation valve for regulating a differential pressure between a wheel cylinder and a master cylinder, a holding valve disposed in a fluid path connecting the differential pressure regulation valve and the wheel cylinder, and an electric pump for discharging brake fluid to a fluid path between the differential pressure regulation valve and the holding valve, and performs an automatic braking process of operating the pump and the differential pressure regulation valve to increase the fluid pressure in the wheel cylinder and decelerate a vehicle. The braking control device for vehicles includes a valve control unit that controls the differential pressure regulation valve and the holding valve; and a motor control unit that controls drive of an electric motor which is a power source of the pump. When a predetermined condition including that a vehicle body deceleration of the vehicle has reached a target vehicle body deceleration is satisfied during the execution of the automatic braking process, the valve control unit performs a valve opening change control routine for having an opening degree of the holding valve smaller than before the predetermined condition is satisfied. Furthermore, under a situation where the opening degree of the holding valve is made smaller than before the predetermined condition is satisfied by the valve opening change control routine during the execution of the automatic braking process, the motor control unit performs a speed change control routine of changing an operating speed of the electric motor from a first operating speed to a second operating speed lower than the first operating speed.

According to the configuration described above, when the execution of the automatic braking process is started, the brake fluid is discharged from the pump and the operation of the differential pressure regulation valve is controlled, and hence the fluid pressure in the wheel cylinder is increased and the braking force is applied to the wheel thus decelerating the vehicle. Then, when the predetermined condition is satisfied, the opening degree of the holding valve becomes smaller by the valve opening change control routine than before the predetermined condition is satisfied. Thus, when the opening degree of the holding valve becomes small, the brake fluid becomes difficult to flow out from the wheel cylinder to the master cylinder side. Then, after making it difficult for the brake fluid to flow out from the wheel cylinder to the master cylinder side in this way, the operating speed of the electric motor is reduced from the first operating speed to the second operating speed by the speed change control routine, that is, the discharge amount of the brake fluid from the pump is reduced. Therefore, in the transition period in which the operating speed of the electric motor is reduced from the first operating speed to the second operating speed, the change in the fluid pressure in the wheel cylinder is suppressed, and thus the lowering in controllability of the vehicle body deceleration of the vehicle in the transition period can be suppressed.

### BRIEF DESCRIPTION OF DRAWINGS

FIG. 1 is a schematic configuration view showing a control device which is one embodiment of a braking control device for a vehicle and a part of a braking device controlled by the control device.

FIG. 2 is a map for deriving a differential pressure command current value with respect to a differential pressure regulation valve.

FIG. 3 is a flowchart describing a processing routine performed by the control device.

FIGS. 4(a) to 4(f) are timing charts for when the vehicle is decelerated by the execution of an automatic braking process.

### DESCRIPTION OF EMBODIMENTS

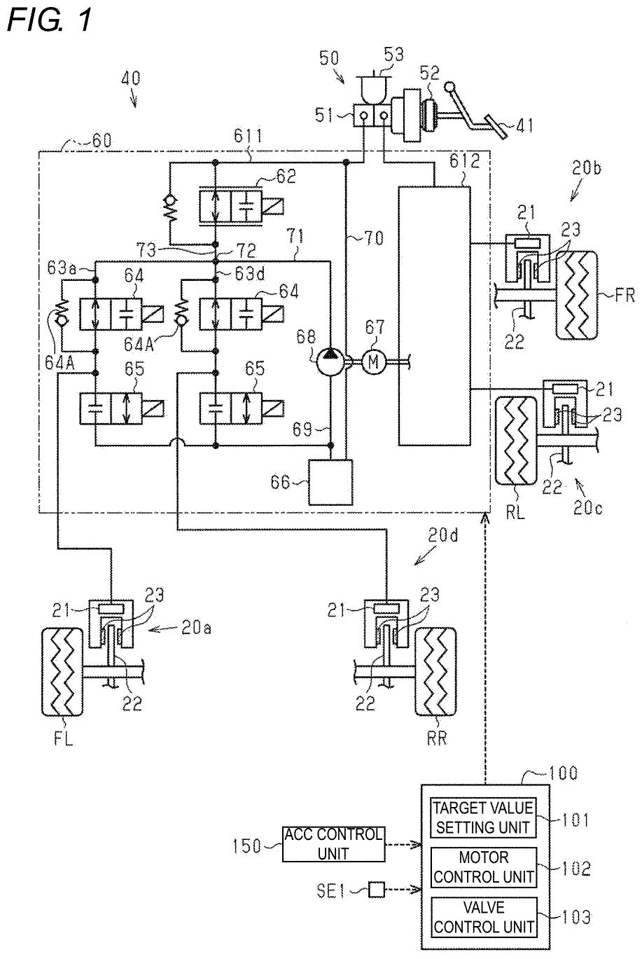

Hereinafter, one embodiment of a braking control device for a vehicle will be described with reference to FIGS. 1 to 4.

FIG. 1 shows a vehicle equipped with a control device 100 which is a braking control device in accordance with the present embodiment. The vehicle includes a plurality of braking mechanisms 20a, 20b, 20c, 20d (i.e., the same number as the wheels) individually provided for the wheels FL, FR, RL, RR, and a braking device 40.

Each of the braking mechanisms 20a to 20d includes a wheel cylinder 21 to which the brake fluid is supplied, a disk rotor 22 serving as an example of a rotary body that integrally rotates with the wheels FL, FR, RL, and RR, and a friction material 23 that relatively moves in a direction of approaching to and a direction of separating from the disk rotor 22. In each of the braking mechanisms 20a to 20d, as the WC pressure Pwc, which is the fluid pressure in the wheel cylinder 21, becomes higher, the force that presses the friction material 23 against the disk rotor 22, that is, the braking force with respect to the wheels FL, FR, RL, and RR increases.

The braking device 40 includes a fluid pressure generator 50 to which a braking operation member 41 such as a brake pedal operated by the driver is connected, and a braking actuator 60 capable of individually regulating the WC pressure Pwc in each wheel cylinder 21. The operation of the braking operation member 41 by the driver can be referred to as “braking operation”, and the force by which the driver operates the braking operation member 41 may be referred to as “braking operation force”.

The fluid pressure generator 50 includes a master cylinder 51, a booster 52 that assists the braking operation force input to the braking operation member 41, and a reservoir tank 53 in which the brake fluid is stored. In the master cylinder 51, when the braking operation force assisted by the booster 52 is input, an MC pressure Pmc which is a fluid pressure corresponding to the braking operation force is generated.

The braking actuator 60 includes two systems of fluid pressure circuits 611 and 612. The wheel cylinder 21 corresponding to the left front wheel FL and the wheel cylinder 21 corresponding to the right rear wheel RR are connected to the first fluid pressure circuit 611. Furthermore, the wheel cylinder 21 corresponding to the right front wheel FR and the wheel cylinder 21 corresponding to the left rear wheel RL are connected to the second fluid pressure circuit 612. When the brake fluid flows into the first and second fluid pressure circuits 611 and 612 from the fluid pressure generator 50, the brake fluid is supplied to the wheel cylinder 21.

In a fluid path connecting the master cylinder 51 and the wheel cylinder 21 in the fluid pressure circuit 611, the differential pressure regulation valve 62 for regulating a differential pressure between the master cylinder 51 and the wheel cylinder 21 is provided. Furthermore, a fluid path 63a for the left front wheel and a fluid path 63d for the right rear wheel are provided on the wheel cylinder 21 side of the differential pressure regulation valve 62 in the first fluid pressure circuit 611. The fluid paths 63a and 63d include a holding valve 64 that is closed when regulating the increase of the WC pressure Pwc, and a pressure reducing valve 65 that is opened when reducing the WC pressure Pwc. That is, the holding valve 64 is disposed in the fluid path on the wheel cylinder 21 side of the differential pressure regulation valve 62. The differential pressure regulation valve 62 is a normally opened linear electromagnetic valve, the holding valve 64 is a normally opened electromagnetic valve, and the pressure reducing valve 65 is a normally closed electromagnetic valve.

In the first fluid pressure circuit 611, the check valve 64A is disposed in parallel to each holding valve 64. Each check valve 64A is a one-way valve for protecting the wheel cylinder 21. Specifically, when the fluid path between the differential pressure regulation valve 62 and the holding valve 64 is assumed as an intermediate fluid path 73, the check valve 64A may flow out the brake fluid in the fluid path connecting the holding valve 64 and the wheel cylinder 21 to the intermediate fluid path 73 when the WC pressure Pwc is higher than the fluid pressure of the intermediate fluid path 73 under the situation where the holding valve 64 is closed. On the other hand, when the fluid pressure in the intermediate fluid path 73 is higher than the WC pressure Pwc under the situation where the holding valve 64 is closed, the check valve 64A regulates the brake fluid in the fluid path connecting the holding valve 64 and the wheel cylinder 21 from flowing out to the intermediate fluid path 73.

A reservoir 66 for temporarily storing the brake fluid that flowed out from the wheel cylinder 21 through the pressure reducing valve 65, and a pump 68 that is operated based on the drive of the electric motor 67 are connected to the first fluid pressure circuit 611. The reservoir 66 is connected to the pump 68 through a suction flow path 69, and is connected to a fluid path on the master cylinder 51 side of the differential pressure regulation valve 62 through the master side flow path 70. The pump 68 is connected to a connecting part 72 between the differential pressure regulation valve 62 and the holding valve 64 through a supply flow path 71. Thus, when the electric motor 67 is driven, the pump 68 pumps out the brake fluid in the master cylinder 51 through the reservoir 66 and discharges the brake fluid to the connecting part 72.

Since the structure of the second fluid pressure circuit 612 is substantially the same as the structure of the first fluid pressure circuit 611, the description of the structure of the second fluid pressure circuit 612 will be omitted in the present description.

Next, the control device 100 will be described with reference to FIG. 1. As shown in FIG. 1, the control device 100 is connected to communicate with an ACC control unit 150 which is a control unit that executes ACC (Adaptive Cruise Control). That is, when the inter-vehicle distance IVD between the own vehicle and the vehicle-in-front is less than the set inter-vehicle distance IVDTr, the ACC control unit 150 calculates a target vehicle body deceleration DVSTh, which is a target value of the vehicle body deceleration of the vehicle, based on the inter-vehicle distance IVD and the set inter-vehicle distance IVDTr, and transmits the target vehicle body deceleration DVSTh to the control device 100.

Furthermore, a vehicle speed sensor SE1 for detecting a vehicle body speed VS of the vehicle is electrically connected to the control device 100. Therefore, when the ACC is executed by the ACC control unit 150, the control device 100 controls the operation of the braking actuator 60 based on the target vehicle body deceleration DVSTh received from the ACC control unit 150 and the vehicle body speed VS detected by the vehicle speed sensor SE1.

Furthermore, as shown in FIG. 1, the control device 100 includes, as functional units for controlling the operation of the braking actuator 60 at the time of execution of the automatic braking process such as the ACC, a target value setting unit 101, a motor control unit 102 and a valve control unit 103.

The target value setting unit 101 sets a target WC pressure PwcTr, which is a target value of the WC pressure Pwc in the wheel cylinder 21, to a larger value the larger the target vehicle body deceleration DVSTh. The target vehicle body deceleration DVSTh is a value calculated based on the inter-vehicle distance IVD as described above. Therefore, it can be said that the target WC pressure PwcTr is a value set based on the inter-vehicle distance IVD.

The motor control unit 102 controls the operating speed Vmt of the electric motor 67, that is, the discharge amount of the brake fluid from each pump 68 based on the signal output from the resolver of the electric motor 67.

The valve control unit 103 individually controls the operation of each differential pressure regulation valve 62, each holding valve 64, and each pressure reducing valve 65 of the braking actuator 60.

At the time of execution of the automatic braking process, the opening degree of the differential pressure regulation valve 62 is regulated by the valve control unit 103 while the drive of the electric motor 67, that is, the discharge of the brake fluid from the pump 68 is controlled by the motor control unit 102. In this case, under the condition that the discharge amount of the brake fluid from the pump 68 is constant, that is, under the condition that the electric motor 67 is being driven at constant speed, the differential pressure of the master cylinder 51 and the wheel cylinder 21 can be increased the smaller the opening degree of the differential pressure regulation valve 62. That is, the WC pressure Pwc in the wheel cylinder 21 can be increased.

Furthermore, under the condition that the differential pressure command current value Ism, which is a current value to be input to the differential pressure regulation valve 62, is held at a constant value, the differential pressure of the master cylinder 51 and the wheel cylinder 21 can be increased the larger the discharge amount of the brake fluid from the pump 68. That is, the WC pressure Pwc in the wheel cylinder 21 can be increased.

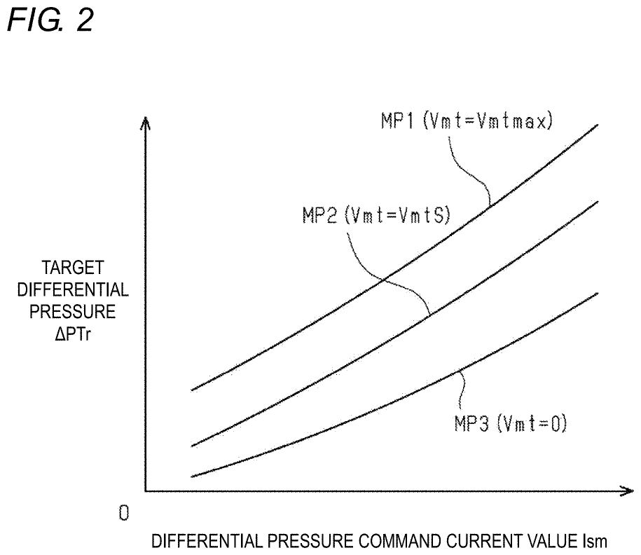

Thus, the valve control unit 103 sets the differential pressure command current value Ism using the map shown in FIG. 2 and inputs the differential pressure command current value Ism to each differential pressure regulation valve 62. The map shown in FIG. 2 represents, for each operating speed Vmt of the electric motor 67, the relationship between the target differential pressure ΔPTr, which is a target value of the differential pressure between the master cylinder 51 and the wheel cylinder 21, and the differential pressure command current value Ism. In FIG. 2, a first characteristic line MP1 represents the relationship between the target differential pressure ΔPTr and the differential pressure command current value Ism when the operating speed Vmt is equal to the maximum value Vmtmax of the operating speed. A second characteristic line MP2 represents the relationship between the target differential pressure ΔPTr and the differential pressure command current value Ism when the operating speed Vmt is equal to the steady speed VmtS smaller than the maximum value Vmtmax of the operating speed. A third characteristic line MP3 represents the relationship between the target differential pressure ΔPTr and the differential pressure command current value Ism when the operating speed Vmt is equal to “0”.

In the map shown in FIG. 2, regardless of the operating speed Vmt of the electric motor 67, the differential pressure command current value Ism becomes larger the larger the target differential pressure ΔPTr. Furthermore, when the target differential pressure ΔPTr is constant, the differential pressure command current value Ism becomes larger the lower the operating speed Vmt of the electric motor 67.

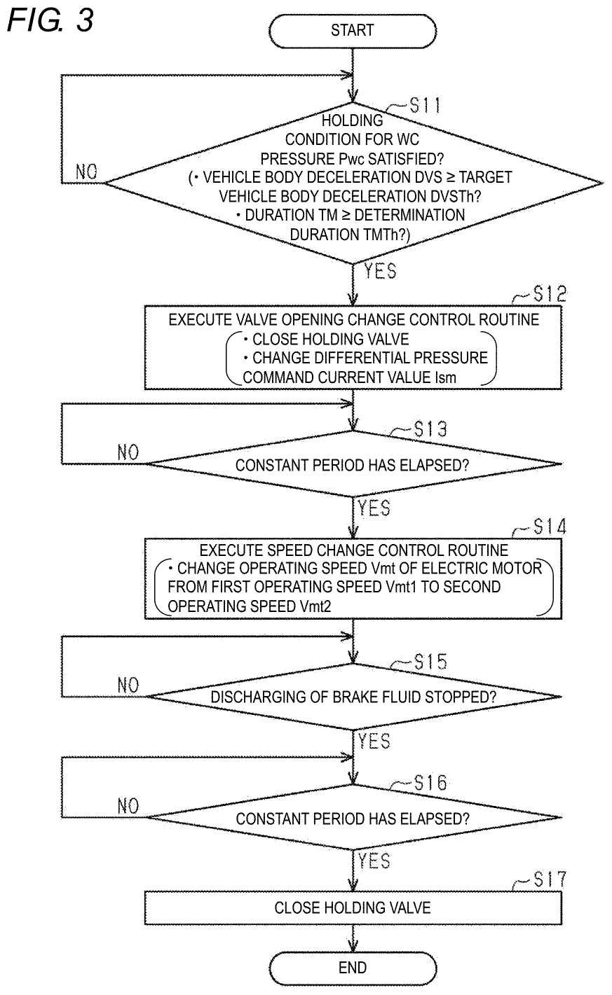

Next, with reference to FIG. 3, a processing routine performed by the control device 100 when holding the WC pressure Pwc in each wheel cylinder 21 during the execution of the automatic braking process such as ACC will be described. The present processing routine is performed on the condition that both the fact the target vehicle body deceleration DVSTh is received and the fact that the braking operation is not performed are satisfied. Then, when the braking operation is detected during the perform of the present processing routine, the present processing routine is terminated.

As shown in FIG. 3, in the present processing routine, first, in step S11, the valve control unit 103 determines whether the holding condition of the WC pressure Pwc is satisfied. The holding condition is such that both the fact that the vehicle body deceleration DVS is greater than or equal to the target vehicle body deceleration DVSTh and the fact that the duration TM of a state where the target WC pressure PwcTr is held is longer than or equal to a determination duration TMTh are satisfied. The holding condition is an example of the “predetermined condition”, and the determination duration TMTh is an example of the “predetermined time”. When the holding condition is satisfied, determination can be made that the possibility that the increase of the WC pressure Pwc is required is low.

When the holding condition is not satisfied (step S11: NO), the determination process of step S11 is repeated. On the other hand, when the holding condition is satisfied (step S11: YES), the process proceeds to the next step S12. In step S12, the valve control unit 103 performs a valve opening change control routine of making the opening degree of each holding valve 64 smaller than that before the holding condition is satisfied, and changing the differential pressure command current value Ism with respect to each differential pressure regulation valve 62 such that the opening degree of the differential pressure regulation valve 62 becomes smaller than that before the holding condition is satisfied. In the present embodiment, the drive of the electric motor 67 is stopped by speed change control routine to be described later. Therefore, in the valve opening change control routine, the valve control unit 103 closes each holding valve 64, and changes the differential pressure command current value Ism with respect to each differential pressure regulation valve 62 to a value when the operating speed Vmt of the electric motor 67 is “0”. That is, the differential pressure command current value Ism increases.

Subsequently, in the next step S13, the motor control unit 102 determines whether a constant time or longer has elapsed from the start of the execution of the valve opening change control routine. The constant time here is set to a length corresponding to the response time of the holding valve 64 and the differential pressure regulation valve 62. When the constant time has not yet passed (step S13: NO), the determination process of step S13 is repeated. On the other hand, when the constant time has already passed (step S13: YES), the process proceeds to the next step S14.

Then, in step S14, the motor control unit 102 performs the speed change control routine to change the operating speed Vmt of the electric motor 67 from the first operating speed Vmt1 to the second operating speed Vmt2. The second operating speed Vmt2 is a speed lower than the first operating speed Vmt1. In the present embodiment, the second operating speed Vmt2 is equal to “0”. That is, the speed change control routine in the present embodiment is a control for stopping the drive of the electric motor 67, that is, the discharge of the brake fluid from the pump 68. Therefore, in the speed change control routine, the drive current value for the electric motor 67 is changed from the value corresponding to the first operating speed Vmt1 to “0”.

Then, in the next step S15, the motor control unit 102 determines whether the discharge of the brake fluid from the pump 68 is stopped. For example, when determination is made that the drive of the electric motor 67 is stopped based on the signal output from the resolver provided in the electric motor 67, the motor control unit 102 can determine that the discharge of the brake fluid is stopped. When determination is not made that the discharge of the brake fluid is stopped (step S15: NO), the determination process of step S15 is repeated.

On the other hand, when determination is made that the discharge of the brake fluid is stopped (step S15: YES), the process proceeds to the next step S16. Then, in step S16, the valve control unit 103 determines whether a constant time has elapsed from when the discharge of the brake fluid was stopped. The constant time here is a value for generating a slight time lag between the stopping of the discharge of the brake fluid and the opening of the holding valve 64 described later.

When the constant time has not yet passed (step S16: NO), the determination process of step S16 is repeated. On the other hand, when the constant time has already passed (step S16: YES), the process proceeds to the next step S17. In step S17, the valve control unit 103 opens the holding valves 64 that have been closed. Thereafter, the present processing routine is terminated.

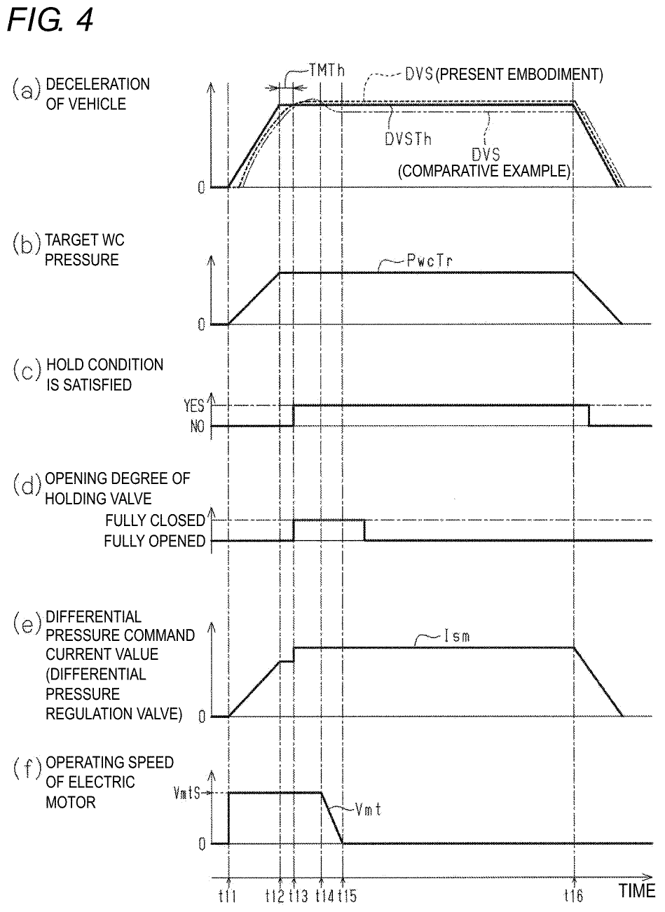

Next, with reference to FIG. 4, the operation when decelerating the vehicle by the execution of the automatic braking process (ACC) will be described together with the effects.

As shown in FIGS. 4(a) to 4(f), when the execution of the automatic braking process is started from the first timing t11 because the inter-vehicle distance IVD between the own vehicle and the preceding vehicle became short, the control device 100 receives the target vehicle body deceleration DVSTh. Then, as shown in FIGS. 4(a) and 4(b), in the period from the first timing t11 to the second timing t12, the target vehicle body deceleration DVSTh gradually increases, so the target WC pressure PwcTr also gradually increases.

That is, the operation of the braking actuator 60 is started from the first timing t11. Then, in the example shown in FIG. 4, as shown in FIGS. 4(b), 4(e), 4(f), the operating speed Vmt of the electric motor 67 is held at the steady speed VmtS, and the differential pressure command current value Ism with respect to each differential pressure regulation valve 62 becomes larger with increase in the target WC pressure PwcTr. Thus, the WC pressure Pwc in each wheel cylinder 21 gradually increases, and hence the vehicle body deceleration DVS of the vehicle increases following the target vehicle body deceleration DVSTh as shown in FIG. 4(a). When the operating speed Vmt is equal to the steady speed VmtS as described above, the differential pressure command current value Ism is derived using the second characteristic line MP2 in FIG. 2.

Then, as shown in FIGS. 4(a) and 4(b), when the second timing t12 is reached, the target vehicle body deceleration DVSTh is held, and thus the target WC pressure PwcTr is also held. At a subsequent third timing t13, the duration TM of the state in which the target WC pressure PwcTr is held reaches the determination duration TMTh. Furthermore, at the third timing t13, the vehicle body deceleration DVS has reached the target vehicle body deceleration DVSTh. That is, as shown in FIG. 4(c), the holding condition of the WC pressure Pwc is satisfied. Therefore, the execution of valve opening change control routine is started. Then, as shown in FIG. 4(d), each holding valve 64 is closed.

The execution of the speed change control routine is started from the fourth timing t14 which a constant time has elapsed from the third timing t13, and thus the drive of the electric motor 67 is stopped, as shown in FIG. 4(f). In the transition period during which the operating speed Vmt is changing, such as from the fourth timing t14 to the fifth timing t15, each holding valve 64 is closed, so that the fluctuation of the WC pressure Pwc in each wheel cylinder 21 is suppressed even if the discharge amount of the brake fluid from the pump 68 is reduced. The lowering in the controllability of the vehicle body deceleration DVS of the vehicle in the transition period can be suppressed by suppressing the lowering in the controllability of the WC pressure Pwc in the transition period.

In the valve opening change control routine of the present embodiment, as shown in FIG. 4(e), the differential pressure command current value Ism with respect to each differential pressure regulation valve 62 is increased than before the holding condition is satisfied, that is, before the third timing t13. More specifically, prior to the start of the execution of the speed change control routine, the differential pressure command current value Ism is changed from a value corresponding to the steady speed VmtS to a value corresponding to “0”. Thus, the fluid pressure in the intermediate fluid path 73 can be made higher than the WC pressure Pwc before the start of the execution of the speed change control routine by increasing the differential pressure command current value Ism prior to the start of the execution of the speed change control routine.

Here, in FIG. 4(a), the transition of the vehicle body deceleration DVS in a comparative example in which the differential pressure command current value Ism is not changed in the valve opening change control routine is shown by a two-dot chain line. In the comparative example, the differential pressure command current value Ism is held at a value corresponding to the steady speed VmtS even after the fourth timing t14 when the operating speed Vmt of the electric motor 67 starts to reduce from the steady speed VmtS. Therefore, even if each holding valve 64 is closed, the fluid pressure in the intermediate fluid path 73 gradually lowers, and the fluid pressure in the intermediate fluid path 73 becomes lower than the WC pressure Pwc. As a result, in the transition period, the brake fluid on the wheel cylinder 21 side relative to the holding valve 64 flows out to the intermediate fluid path 73 side through the check valve 64A, and the WC pressure Pwc in each wheel cylinder 21 lowers. Thus, as indicated by a two-dot chain line in FIG. 4(a), the vehicle body deceleration DVS reduces in the transition period. Such reduction in the WC pressure Pwc and the vehicle body deceleration DVS may continue as long as the fluid pressure in the intermediate fluid path 73 is lower than the WC pressure Pwc, even after the transition period is ended.

On the other hand, in the present embodiment, the drive of the electric motor 67 is stopped after the differential pressure command current value Ism is changed to a value corresponding to when the operating speed Vmt is equal to “0”. Therefore, even if the drive of the electric motor 67 is stopped, the fluid pressure in the intermediate fluid path 73 is less likely to become lower than the WC pressure Pwc. As a result, the reduction in the WC pressure Pwc in the transition period can be suppressed, and furthermore, the reduction in the vehicle body deceleration DVS can be suppressed.

When the state in which the inter-vehicle distance IVD of the own vehicle and the preceding vehicle is less than the set inter-vehicle distance IVDTr is resolved at the subsequent sixth timing t16, as shown in FIGS. 4(a) and 4(b), the target vehicle body deceleration DVSTh reduces and hence the target WC pressure PwcTr also lowers. Thus, the differential pressure command current value Ism is reduced, and hence the WC pressure Pwc in each wheel cylinder 21 reduces following the target WC pressure PwcTr. The vehicle body deceleration DVS of the vehicle thus also reduces.

The above embodiment may be modified to another embodiment as described below.

In the embodiment described above, a case where the valve opening change control routine and the speed change control routine are executed at the time of executing the ACC to decelerate the own vehicle so that the inter-vehicle distance IVD between the preceding vehicle and the own vehicle is not reduced. However, in the automatic braking in which the braking force is applied to the vehicle under a situation where the braking operation is not performed, the valve opening change control routine and the speed change control routine may be performed at the time of the execution of other automatic braking processes other than the ACC.

In the valve opening change control routine of the embodiment described above, the differential pressure command current value Ism is changed at once from the value corresponding to the first operating speed Vmt1 to the value corresponding to the second operating speed Vmt2. However, the present invention is not limited thereto, and the differential pressure command current value Ism may be gradually changed from the value corresponding to the first operating speed Vmt1 toward the value corresponding to the second operating speed Vmt2.

In the valve opening change control routine, if the fluid pressure in the intermediate fluid path 73 can be made higher than the WC pressure Pwc, the differential pressure command current value Ism may be changed to a value different from the value corresponding to the second operating speed Vmt2. However, after the operating speed Vmt of the electric motor is held at the second operating speed Vmt2, the differential pressure command current value Ism is preferably set to a value corresponding to the second operating speed Vmt2.

In the valve opening change control routine, the differential pressure command current value Ism may be changed after the opening degree of the holding valve 64 is made smaller than that before the holding condition is satisfied. For example, the differential pressure command current value Ism may be changed within a period from when the opening degree of the holding valve 64 is changed to when the speed change control routine is started. Furthermore, the differential pressure command current value Ism may be changed when reducing the operating speed Vmt of the electric motor 67 by the execution of the speed change control routine.

In the valve opening change control routine, the holding valve 64 may not be closed if the opening degree of the holding valve 64 is made smaller than that before the holding condition is satisfied. Even in such a case, the outflow of the brake fluid from the wheel cylinder 21 and the inflow of the brake fluid to the wheel cylinder 21 can be suppressed by making the opening degree of the holding valve 64 smaller by the execution of the valve opening change control routine. The fluctuation of the WC pressure Pwc in the transition period thus can be suppressed.

In the valve opening change control routine of the embodiment described above, all the holding valves 64 are closed. However, in the valve opening change control routine, some holding valves 64 (e.g., the holding valves 64 corresponding to the front wheels FL and FR) of the holding valves 64 may be closed, and the remaining holding valves 64 (e.g., the holding valves 64 corresponding to the rear wheels RL and RR) may not be closed. In this case, the opening degree of the remaining holding valve 64 is preferably made smaller than before the holding condition is satisfied.

In the speed change control routine, the drive of the electric motor 67 does not have to be stopped if the operating speed Vmt of the electric motor 67 is reduced. That is, the second operating speed Vmt2 may be higher than “0” as long as it is lower than the first operating speed Vmt1.

1. (canceled)

2. (canceled)

3. (canceled)

4. (canceled)

5. A braking control device for vehicles applied to a braking device including a differential pressure regulation valve for regulating a differential pressure between a wheel cylinder and a master cylinder, a holding valve disposed in a fluid path connecting the differential pressure regulation valve and the wheel cylinder, and an electric pump for discharging brake fluid to a fluid path between the differential pressure regulation valve and the holding valve, the braking control device performing an automatic braking process of operating the pump and the differential pressure regulation valve to increase a fluid pressure in the wheel cylinder and decelerate a vehicle,
the braking control device for vehicles comprising:
a valve control unit that controls the differential pressure regulation valve and the holding valve; and
a motor control unit that controls drive of an electric motor which is a power source of the pump, wherein
when a predetermined condition including a fact that a vehicle body deceleration of the vehicle has reached a target vehicle body deceleration is satisfied during the execution of the automatic braking process, the valve control unit performs a valve opening change control routine in which an opening degree of the holding valve is made smaller than before the predetermined condition is satisfied, and
after a start of the valve opening change control routine, under a situation where the opening degree of the holding valve is made smaller than before the predetermined condition is satisfied by the valve opening change control routine during the execution of the automatic braking process, the motor control unit performs a speed change control routine of changing an operating speed of the electric motor from a first operating speed to a second operating speed lower than the first operating speed.

6. The braking control device for vehicles according to claim 5, wherein the braking device includes a check valve that, when a fluid pressure in the wheel cylinder is higher than a fluid pressure of an intermediate fluid path, which is a fluid path between the differential pressure regulation valve and the holding valve, flows out a brake fluid in a fluid path connecting the holding valve and the wheel cylinder to the intermediate fluid path, the valve control unit changes a differential pressure command current value with respect to the differential pressure regulation valve so that the opening degree of the holding valve becomes smaller than that before the predetermined condition is satisfied, and the opening degree of the differential pressure regulation valve becomes smaller than before the predetermined condition is satisfied in the valve opening change control routine, and the motor control unit performs the speed change control routine under a situation where the opening degree of the holding valve is made smaller than before the predetermined condition is satisfied by the valve opening change control routine and the differential pressure command current value is changed from before the predetermined condition is satisfied during the execution of the automatic braking process.

7. The braking control device for vehicles according to claim 6, wherein the valve control unit changes the differential pressure command current value from a value corresponding to the first operating speed to a value corresponding to the second operating speed in the valve opening change control routine.

8. The braking control device for vehicles according to any one of claim 5, further comprising a target value setting unit configured to set a target value of a fluid pressure in the wheel cylinder based on an inter-vehicle distance with a preceding vehicle, wherein during the execution of the automatic braking process, the valve control unit performs the valve opening change control routine assuming the predetermined condition is satisfied when both a fact that the vehicle body deceleration reached the target vehicle body deceleration and a fact that a state in which the target value of the fluid pressure set by the target value setting unit is held is continued for a predetermined time or longer are satisfied.

9. The braking control device for vehicles according to any one of claim 6, further comprising a target value setting unit configured to set a target value of a fluid pressure in the wheel cylinder based on an inter-vehicle distance with a preceding vehicle, wherein during the execution of the automatic braking process, the valve control unit performs the valve opening change control routine assuming the predetermined condition is satisfied when both a fact that the vehicle body deceleration reached the target vehicle body deceleration and a fact that a state in which the target value of the fluid pressure set by the target value setting unit is held is continued for a predetermined time or longer are satisfied.

10. The braking control device for vehicles according to any one of claim 7, further comprising a target value setting unit configured to set a target value of a fluid pressure in the wheel cylinder based on an inter-vehicle distance with a preceding vehicle, wherein during the execution of the automatic braking process, the valve control unit performs the valve opening change control routine assuming the predetermined condition is satisfied when both a fact that the vehicle body deceleration reached the target vehicle body deceleration and a fact that a state in which the target value of the fluid pressure set by the target value setting unit is held is continued for a predetermined time or longer are satisfied.
